(19) United States
(12) Patent Application Publication
(10) Pub. No.: US 2012/0040681 A1
(43) Pub. Date: Feb. 16, 2012

(54) AREA-TRIGGERED LOCATION SERVICE METHOD, LOCATION SERVICE SERVER, AND LOCATION SERVICE TERMINAL

(75) Inventors: Wei Yan, Nanjing (CN); Fang Ji, Nanjing (CN)

(73) Assignee: Huawei Technologies Co., Ltd., Shenzhen (CN)

(21) Appl. No.: 13/278,714

(22) Filed: Oct. 21, 2011

Related U.S. Application Data
(63) Continuation of application No. PCT/CN2010/072076, filed on Apr. 22, 2010.

(30) Foreign Application Priority Data
Apr. 23, 2009 (CN) 200910137617.7

(51) Int. Cl. H04W 36/32; H04W 64/00

(52) U.S. Cl. 455/440; 455/456.2

(57) ABSTRACT

An area-triggered location service method is provided, which includes: receiving, by a location service server, area-triggered location service request information; saving, by the location service server, identification information of a location service terminal and a triggered report condition carried in the area-triggered location service request information; sending, by the location service server, a subscription instruction to the location service terminal according to the identification information of the location service terminal, so that the location service terminal reports location information of a cell in which the location service terminal is located after receiving the subscription instruction; receiving, by the location service server, the cell location information reported by the location service terminal; and judging, whether the cell location information meets the triggered report condition, and sending area-triggered notification information of the location service terminal if the cell location information meets the triggered report condition.

### CROSS-REFERENCE TO RELATED APPLICATIONS

This application is a continuation of International Application No. PCT/CN2010/072076, filed on Apr. 22, 2010, which claims priority to Chinese Patent Application No. 200910137617.7, filed on Apr. 23, 2009, both of which are hereby incorporated by reference in their entireties.

### TECHNICAL FIELD

The present invention relates to the field of mobile communications, and in particular, to an area-triggered location service method, and a location service server and a location service terminal for implementing the method.

### BACKGROUND

The location service of the mobile communication network, also known as the mobile location-based service, refers to that a mobile network acquires geographical location information (longitude and latitude coordinates) of a location service terminal through a specific location technology, provides the geographical location information for a mobile user, a communication system, or a third party service application, and provides a location-related calling or non-calling service to the mobile user with the support of some electronic map information.

Referring to FIG. 1, FIG. 1 is a schematic diagram of a location service system of a mobile communication system in the prior art. The location service system mainly includes conventional network entities, such as a location service terminal, a Mobile Switching Center (MSC), a Home Location Register (HLR), and a packet domain Serving GPRS Supporting Node (SGSN), and newly added important functional entities: a location service server and a location service client. The location service terminal, the location service server, and the location service client may be connected through a No. 7 signaling network. The location service server may connect to the MSC and the HLR through the No. 7 signaling network, or in other communication and connection manners.

The location service terminal is a user end device of the location service, and mainly serves to provide location service-related measurement information of the location service terminal, and complete the implementation of a part of the application of the location service at the same time.

The location service server, as a functional entity for providing location information, provides location information of a location service terminal user according to requirements of the location service client, and may be a specific network device, for example, a gateway mobile location center or a mobile location service center, and may also be a logic module attached to the network device.

The location service client is a functional entity interacting with the location service server to acquire the location information of the location service terminal user, and may be a location service terminal, a mobile network device, or a third party service application.

An area-triggered location service request is defined in the prior art, and refers to that a request end pre-designates a target area range and a triggered location report event, and a location report is reported to the request end when the location service terminal enters, exits, or is located in the designated target area range. In the prior art, an area may be defined as a geographical area, which may be a Mobile Country Code (MCC), a mobile operation network identification, or a corresponding geographical location name in a map, for example, xx street. The location service server saves and translates, for example, a Cell Identity (Cellid), a Location Area Identification (LAI), a Routing Area Identification (RAI), an MCC, or a Mobile Network Code (MNC) in a target area.

In the prior art, a specific technical solution of an area-triggered location service method includes the following. A location service client sends area-triggered location service request information to a location service server, where the area-triggered location service request information includes target area information, identification information of a location service terminal, and a target-area-triggered report rule. After receiving the area-triggered location service request information, the location service server performs logic processing on the area-triggered location service request, mainly including tasks such as translation of a target area and privacy judgment, and then forwards the area-triggered location service request information to the location service terminal. The location service terminal stores information such as a designated target area range and the target-area-triggered report rule, monitors the target area range, and reports a location report to the location service server when the location service terminal monitors that a triggered location report event occurs, for example, an object enters, exits, or is located in the designated target area range. The location service server forwards the location report to the location service client, to notify the corresponding location service client request end that the designated triggered location report event has been reported.

In an area-triggered location information request process provided in the prior art, the location service server mainly serves to process the area-triggered location service request information sent by the location service client, and forward response information of the area-triggered location service request information and an area change report notification; and the location service terminal mainly servers to save the target area information and the target-area-triggered report rule, and report the area change report notification information after detecting the required area-triggered event.

In the implementation of the present invention, the inventors find that in the area-triggered location service method in the prior art, the location service terminal needs to implement tasks such as saving an area trigger and processing the target-area-triggered report rule, and therefore, the logic processing is complex and a high performance of the location service terminal is required.

In addition, when the location service system adjusts the target-area-triggered report rule, for example, the location service system requires the location service terminal to be periodically triggered in the target area, and to report the area change report notification information after cell handover beyond the target area, software upgrade of the location service terminal is needed as the location service terminal cannot support a new target-area-triggered report rule in the prior art; however, the operation difficulty for software upgrade is grave.

### SUMMARY

In order to solve the technical problems, embodiments of the present invention provide an area-triggered location service method, through which the logic processing of a location service terminal can be simplified and the adjustment of a target-area-triggered report rule can be simply achieved in a location service system, and a location service server and a location service terminal for implementing the method.

An area-triggered location service method provided in an embodiment of the present invention includes: receiving, by a location service server, area-triggered location service request information; saving, by the location service server, identification information of a location service terminal, target area information, and a triggered report condition which are carried in the area-triggered location service request information; sending, by the location service server, a subscription instruction to the location service terminal according to the saved identification information of the location service terminal, so that the location service terminal reports location information of a cell in which the location service terminal currently is located after cell handover or area handover after receiving the subscription instruction; receiving, by the location service server, the cell location information reported by the location service terminal; and judging, by the location service server, whether the location information of the cell in which the location service terminal is located meets the triggered report condition, and sending area-triggered notification information of the location service terminal if the location information of the cell in which the location service terminal is located meets the triggered report condition.

A location service server provided in an embodiment of the present invention includes: a first receiving unit, configured to receive area-triggered location service request information; a first storage unit, configured to save identification information of a location service terminal and a triggered report condition which are carried in the area-triggered location service request information; a first sending unit, configured to send a subscription instruction to the location service terminal according to the identification information of the location service terminal saved in the first storage unit, so that the location service terminal reports location information of a cell in which the location service terminal is currently located after cell handover or area handover after receiving the subscription instruction; a second receiving unit, configured to receive the cell location information reported by the location service terminal; and a processing unit, configured to judge whether the cell location information meets the triggered report condition, and send area-triggered notification information of the location service terminal after judging that the cell location information meets the triggered report condition.

An area-triggered location service method provided in an embodiment of the present invention includes: receiving a subscription instruction; detecting the type of the subscription instruction; reporting location information of a current cell after cell handover, if the type of the subscription instruction is detected to be a cell handover subscription instruction; and reporting location information of a current cell after area handover, if the type of the subscription instruction is detected to be an area handover subscription instruction.

A location service terminal provided in an embodiment of the present invention includes: a receiving unit, configured to receive a subscription instruction; a detection unit, configured to detect the type of the subscription instruction; a first processing unit, configured to report location information of a current cell, after the detection unit detects that the type of the subscription instruction is a cell handover subscription instruction, and the location service terminal undergoes cell handover; and a second processing unit, configured to report location information of a current cell, after the detection unit detects that the type of the subscription instruction is an area handover subscription instruction, and the location service terminal undergoes area handover.

In the embodiments of the present invention, the location service terminal reports the location information of the cell in which the location service terminal is located after area handover or cell handover, and the location service server judges whether the cell location information meets the triggered report condition according to the received cell location information. Compared with the target-area-triggered location service method in the prior art, the location service terminal according to the embodiments of the present invention does not need to save an area-triggered task and process the target-area-triggered report rule, so as to lighten the burden of the location service terminal, and lower the production cost of the location service terminal. In addition, in the embodiments of the present invention, when the target-area-triggered report rule needs to be adjusted, the adjustment can be directly performed at the location service server end, without the need of software upgrade of the location service terminal, which lowers the operation difficulty.

### BRIEF DESCRIPTION OF THE DRAWINGS

FIG. 1 is a schematic diagram of a location service system of a mobile communication network in the prior art;

FIG. 2 is a flow chart of an area-triggered location service method according to an embodiment of the present invention;

FIG. 3 is a flow chart of judging whether location information of a cell in which a location service terminal is located meets a triggered report condition according to an embodiment of the present invention;

FIG. 4 is a schematic diagram of a location service server according to an embodiment of the present invention;

FIG. 5 is a schematic diagram of a first embodiment of a processing unit in a location service server according to an embodiment of the present invention;

FIG. 6 is a schematic diagram of a second embodiment of a processing unit in a location service server according to an embodiment of the present invention;

FIG. 7 is a schematic diagram of a third trigger sub-unit in a location service server according to an embodiment of the present invention;

FIG. 8 is a flow chart of a method for processing a subscription instruction according to an embodiment of the present invention;

FIG. 9 is a schematic diagram of an apparatus for processing a subscription instruction according to an embodiment of the present invention; and

FIG. 10 is a schematic diagram of a service process of an area-triggered location service system according to an embodiment of the present invention.

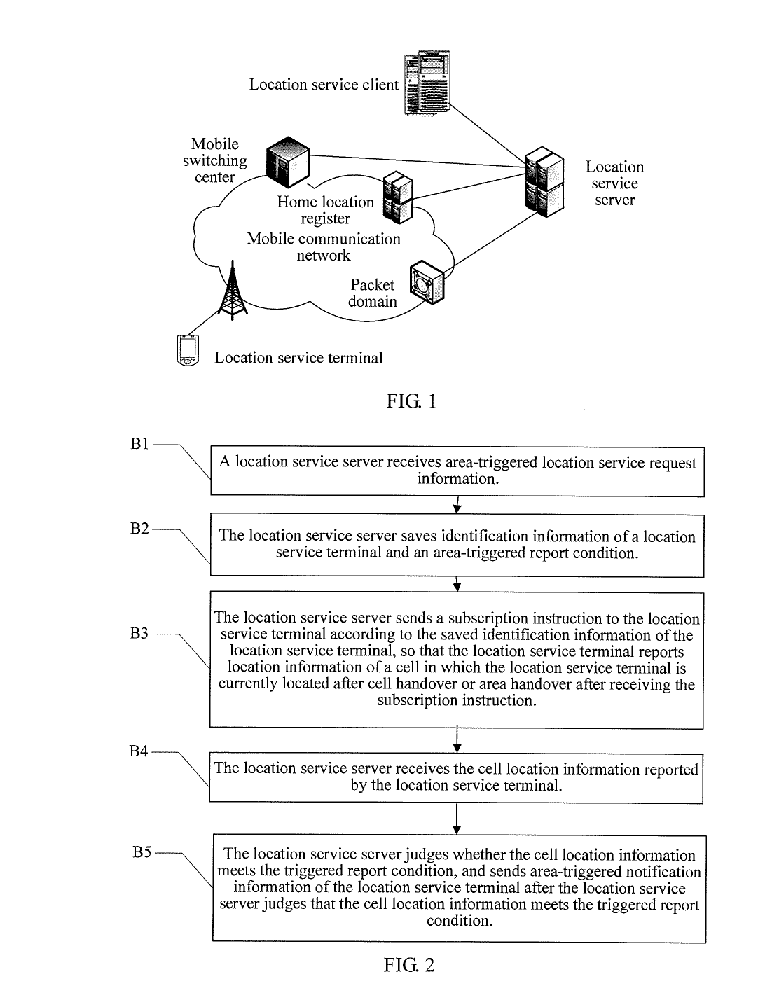

### DETAILED DESCRIPTION OF THE EMBODIMENTS

An area-triggered location service method, and a location service server and a location service terminal for implementing the method which are provided by the present invention are described in detail below with reference to the accompanying drawings.

Referring to FIG. 2, FIG. 2 is a flow chart of an area-triggered location service method according to an embodiment of the present invention.

Step B1: A location service server receives area-triggered location service request information.

The location service server receives the area-triggered location service request information from a location service client, where the area-triggered location service request information may be forwarded to the location service server by an intermediate device.

Step B2: The location service server saves identification information of a location service terminal and an area-triggered report condition.

The location service server saves the identification information of the location service terminal and the area-triggered report condition which are carried in the area-triggered location service request information.

Step B3: The location service server sends a subscription instruction to the location service terminal according to the saved identification information of the location service terminal, so that the location service terminal reports location information of a cell in which the location service terminal is currently located after cell handover or area handover after receiving the subscription instruction.

The location service server sends the subscription instruction to the corresponding location service terminal according to the saved identification information of the location service terminal, and then performs step B4. The subscription instruction may be a cell handover subscription instruction or an area handover subscription instruction. The cell handover subscription instruction or the area handover subscription instruction may be sent to the location service terminal in manners of a short message, Unstructured Supplementary Services Data (USSD) or TCP/IP.

The location service terminal reports location information of a cell in which the location service terminal is currently located after cell handover after receiving the cell handover subscription instruction, and reports location information of a cell in which the location service terminal is currently located after area handover after receiving the area handover subscription instruction.

Step B4: The location service server receives the cell location information reported by the location service terminal.

The location service terminal reports its cell location information after receiving the subscription instruction, and the location service server receives the cell location information reported by the location service terminal.

Step B5: The location service server sends area-triggered notification information of the location service terminal after judging that the cell location information meets the triggered report condition.

The location service server judges whether the location information of the cell in which the location service terminal is currently located meets the triggered report condition according to the received cell location information, where the triggered report condition includes other information such as a target-area-triggered report rule and the type of a trigger event, and sends area-triggered notification information of the location service terminal to the location service client if the location service server judges that the cell location information meets the triggered report condition, which completes this area-triggered location service process.

In the embodiment of the area-triggered location service method of the present invention, the location service server judges whether the current cell location information of the location service terminal meets the triggered report condition after receiving the cell location information reported by the location service terminal. Compared with the prior art, the location service terminal only needs to report the location information of the cell in which the location service terminal is currently located after cell handover or area handover, without saving the target area information and processing the target-area-triggered report rule, which lightens the burden of the location service terminal and lowers the production cost of the location service terminal. In addition, when the target-area-triggered report rule needs to be adjusted, the target-area-triggered report rule can be directly adjusted at the location service server end, without the need of software upgrade of the location service terminal, which lowers the operation difficulty.

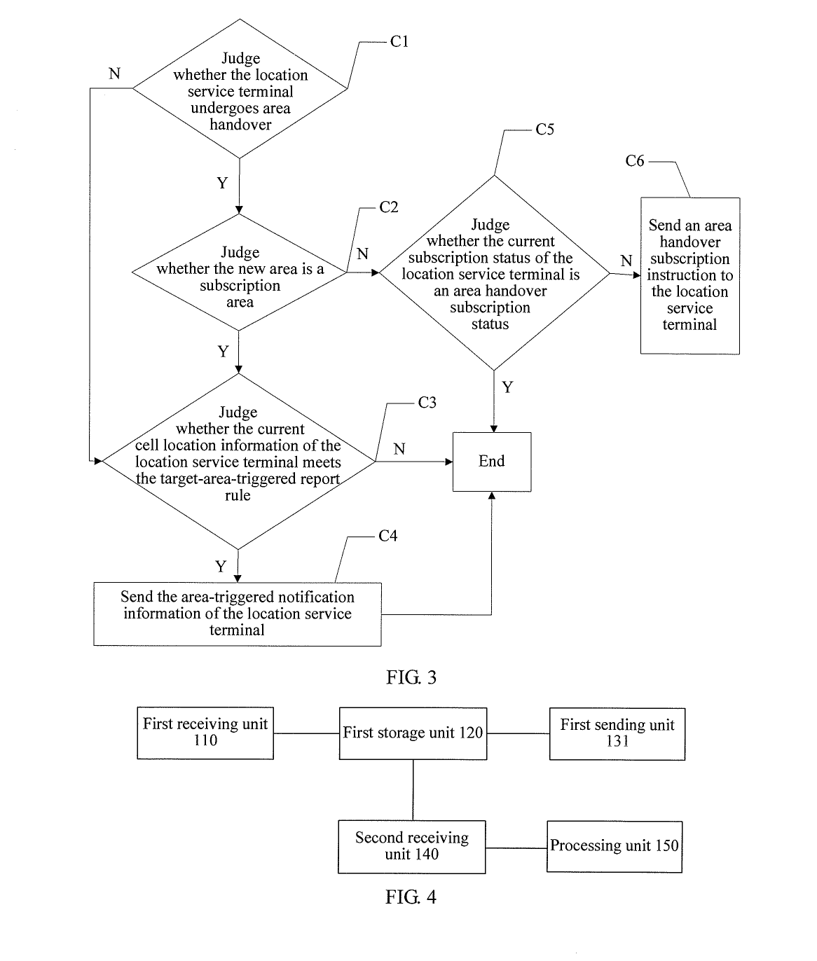

Referring to FIG. 3, FIG. 3 is a flowchart of judging whether the location information of a cell in which the location service terminal is located meets the triggered report condition according to an embodiment of the present invention.

In the foregoing method embodiment, the step of judging whether the location information of the cell in which the location service terminal is located meets the triggered report condition specifically includes the following steps.

Step C1: Judge whether the location service terminal undergoes area handover.

It is judged whether the location service terminal undergoes area handover according to the received cell location information. If the received cell location information is not reported by the location service terminal for the first time, it is judged whether an area identification in the cell location information is changed, and if the area identification is judged to be changed, it is judged that the location service terminal undergoes area handover, that is, the location service terminal moves to a new area, and then step C2 is performed; while if the area identification is judged to be not changed, it is judged that the location service terminal does not undergo area handover, that is, the location service terminal reports its cell location information after cell handover, and therefore, the location service terminal is judged to be located in a subscription area, and step C3 is performed.

The location service terminal reports the location information of the cell in which the location service terminal is currently located immediately after receiving the subscription instruction, the cell location information received by the location service server is reported by the location service terminal for the first time, and then it is judged that the location service terminal undergoes area handover.

Step C2: Judge whether the new area is a subscription area.

The area-triggered location service request information includes target area information, and the location service server judges whether a target area exists in the area in which the location service terminal is located, that is, whether a Cellid that is the same as a target area corresponding to the target area information exists in the area. If the area in which the location service terminal is located is judged to be a subscription area, a target area exists in the new area, and step C3 is performed. If the new area is judged to be a non-subscription area, step C5 is performed, and it is judged whether the current subscription status of the location service terminal is an area handover subscription status.

Step C3: Judge whether the current cell location information of the location service terminal meets the target-area-triggered report rule.

The location service server judges that it is not the first time for the location service terminal to report the cell location information, so it is considered that the cell location information is reported by the location service terminal after cell handover in the subscription area, and accordingly, the location service server further judges whether the current cell location information of the location service terminal meets the target-area-triggered report rule delivered by the location service client. If it is judged that the current cell location information of the location service terminal meets the target-area-triggered report rule, step C4 is performed; while if it is judged that the current cell location information of the location service terminal does not meet the target-area-triggered report rule, the judgment process is terminated.

Step C4: Send the area-triggered notification information of the location service terminal.

The location service server may send the area-triggered notification information of the location service terminal to the location service client, and then terminate this judgment process. The location service client completes corresponding application processing according to area change notification information of the location service terminal.

Step C5: Judge whether the current subscription status of the location service terminal is an area handover subscription status.

When the location service terminal is currently located in a non-subscription area, the location service server judges whether the current subscription status of the location service terminal is an area handover subscription status. If the location service server judges that the current subscription status of the location service terminal is an area handover subscription status, it indicates that the location service terminal reports its cell location information after area handover, and this judgment process is terminated. When the location service terminal reports its cell location information after another area handover, this judgment process is performed again. While if the location service server judges that the current subscription status of the location service terminal is not an area handover subscription status, step C6 is performed.

Step C6: Send an area handover subscription instruction to the location service terminal.

When the location service terminal is currently located in a non-subscription area, the location service server judges that the current subscription status of the location service terminal is a cell handover subscription status, and sends the area handover subscription instruction to the location service terminal. This judgment process is performed again when the location service terminal reports its cell location information after area handover.

In the method embodiment of the present invention, a step of judging the subscription status of the location service terminal is further included between steps C2 and C3.

Step D1: Judge the current subscription status of the location service terminal.

After the new area in which the location service terminal is located is judged to be a subscription area, the current subscription status of the location service terminal is further judged. If it is judged that the current subscription status of the location service terminal is an area handover subscription status, step D2 is judged; while if it is judged that the current subscription status of the location service terminal is not an area handover subscription status, step C3 is triggered and performed.

Step D2: Deliver a cell handover subscription instruction to the location service terminal.

When the current area of the location service terminal is a subscription area, the location service server delivers the cell handover subscription instruction to the location service terminal after judging that the current subscription status of the location service terminal is an area handover subscription status, and then step C3 is triggered and performed.

The location service terminal reports the location information of the cell in which the location service terminal is currently located after cell handover in the subscription area.

To sum up, in the embodiment of the location service method of the present invention, the location service terminal reports the location information of the cell in which the location service terminal is currently located immediately after receiving the subscription instruction for the first time. The location service server sends the cell handover subscription instruction to the location service terminal after judging that the location service terminal is located in a subscription area and the subscription status is an area handover subscription status, and the location service terminal reports the location information of the cell in which the location service terminal is currently located after cell handover. The location service server sends an area handover subscription instruction to the location service terminal after judging that the location service terminal is located in a non-subscription area and the subscription status is a cell handover subscription status, and the location service terminal reports the location information of the cell in which the location service terminal is currently located after area handover. The location service server processes the target-area-triggered report rule according to the cell location information reported by the location service terminal, and sends the area-triggered notification information to the location service client after judging that the location information of the cell in which the location service terminal is located meets the target-area-triggered report rule. The task of processing the target-area-triggered report rule is performed by the location service server, and the location service terminal does not need to perform the complex target-area-triggered report rule, so that the production cost of the location service terminal is lowered, and the location service terminal only needs to report the location information of the cell in which the location service terminal is located after cell handover or area handover.

In addition, when the target-area-triggered report rule is adjusted, the target-area-triggered report rule is adjusted directly at the location service server end, without software upgrade of the location service terminal, which lowers the operation difficulty.

The present invention further provides an apparatus embodiment for implementing the foregoing method. FIG. 4 is a schematic diagram of a location service server according to an embodiment of the present invention.

The location service server according to the embodiment of the present invention includes a first receiving unit 110, a first storage unit 120, a first sending unit 131, a second receiving unit 140, and a processing unit 150.

The first receiving unit 110 is configured to receive area-triggered location service request information.

The first storage unit 120 is configured to save identification information of a location service terminal and a triggered report condition which are carried in the area-triggered location service request information.

The first sending unit 131 is configured to deliver a subscription instruction to the location service terminal according to the identification information of the location service terminal saved by the first storage unit 120, so that the location service terminal reports location information of a cell in which the location service terminal is currently located after cell handover or area handover after receiving the subscription instruction. The subscription instruction delivered by the first sending unit 131 to the location service terminal may be a cell handover subscription instruction or an area handover subscription instruction.

The second receiving unit 140 is configured to receive the cell location information reported by the location service terminal.

The processing unit 150 is configured to judge whether the cell location information meets the triggered report condition, and send area-triggered notification information of the location service terminal after judging that the cell location information meets the triggered report condition.

In the prior art, the location service terminal is responsible for processing a target-area-triggered report rule, and sending the area change report notification information to the location service server if the location service terminal meets the target-area-triggered report rule. In the embodiment of the location service server of the present invention, after the second receiving unit 140 receives the cell location information reported by the location service terminal, the processing unit 150 sends the area-triggered notification information of the location service terminal to the location service client after judging that the location information of the cell in which the location service terminal is located meets the triggered report condition, so that the location service terminal does not need to process the target-area-triggered report rule, which lowers the production cost of the location service terminal. In addition, when the target-area-triggered report rule is adjusted, the target-area-triggered report rule is directly adjusted at the location service server end, without the need of software upgrade of the location service terminal, which lowers the operation difficulty.

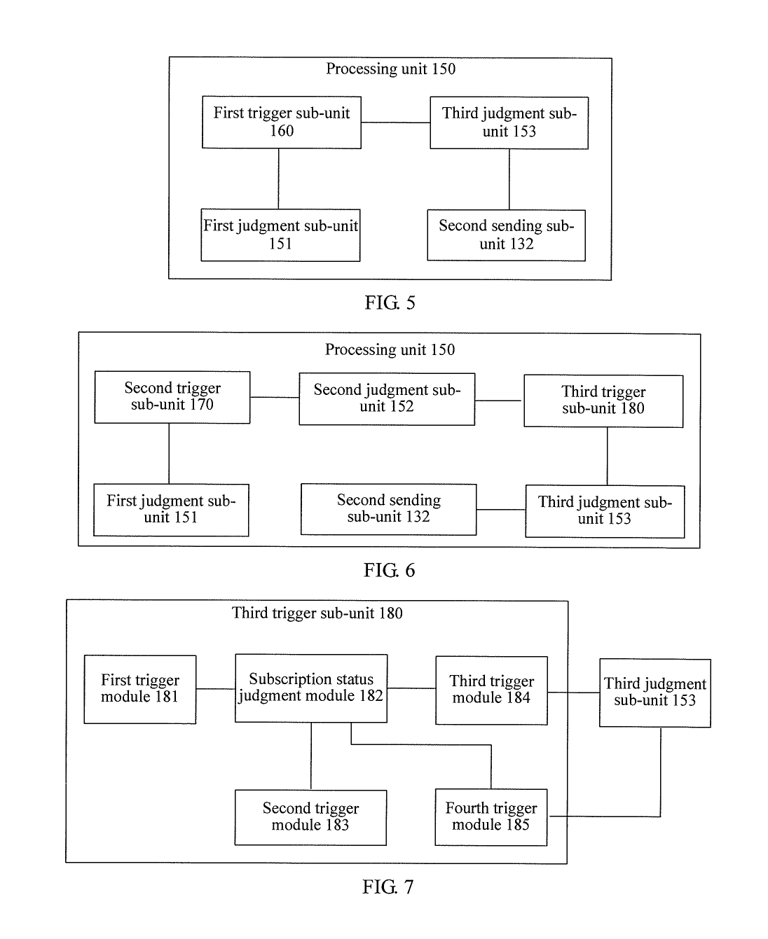

Referring to FIG. 5, FIG. 5 is a schematic diagram of a first embodiment of the processing unit in the location service server according to an embodiment of the present invention.

The processing unit 150 mainly includes a first judgment sub-unit 151, a first trigger sub-unit 160, a third judgment sub-unit 153, and a second sending sub-unit 132.

The first judgment sub-unit 151 is configured to judge whether the location service terminal undergoes area handover according to the received cell location information.

The first trigger sub-unit 160 is configured to trigger the third judgment sub-unit 153 to judge whether the location information of the cell in which the location service terminal is located meets a target-area-triggered report rule, after the first judgment sub-unit 151 judges that the location service terminal does not undergo area handover.

If the first judgment sub-unit 151 judges that the location service terminal does not undergo area handover according to the cell location information reported by the location service terminal, it indicates that the location service terminal is in a cell handover subscription status.

The third judgment sub-unit 153 is configured to judge, according to the received cell location information, whether the location information of the cell in which the location service terminal is located meets the target-area-triggered report rule.

The second sending sub-unit 132 is configured to send the area-triggered notification information of the location service terminal, after the third judgment sub-unit 153 judges that the location information of the cell in which the location service terminal is located meets the target-area-triggered report rule.

In the prior art, the location service terminal is responsible for processing the target-area-triggered report rule, and sending the area change report notification information to the location service server when the location service terminal meets the target-area-triggered report rule. In the location service server of the present invention, after the first judgment sub-unit 151 judges that the location service terminal is currently located in a subscription area and undergoes cell handover, the first trigger sub-unit 160 triggers the third judgment sub-unit 153 to judge whether the location information of the cell in which the location service terminal is located meets the target-area-triggered report rule, and the second sending sub-unit 132 sends the area-triggered notification information of the location service terminal outward after the third judgment sub-unit 153 judges that the current cell location information of the location service terminal meets the area-triggered report rule. Therefore, the location service terminal does not need to process the target-area-triggered report rule, which lowers the production cost of the location service terminal. In addition, when the target-area-triggered report rule is adjusted, the target-area-triggered report rule is directly adjusted at the location service server end, without the need of software upgrade of the location service terminal, which lowers the operation difficulty.

Referring to FIG. 6, FIG. 6 is a schematic diagram of a second embodiment of the processing unit in the location service server according to an embodiment of the present invention.

The processing unit 150 includes;

a first judgment sub-unit 151, configured to judge, according to the received cell location information, whether the location service terminal undergoes area handover;

a second trigger sub-unit 170, configured to trigger the second judgment sub-unit 152 to judge whether the area in which the location service terminal is located is a subscription area, after the first judgment sub-unit judges that the location service terminal undergoes area handover;

a second judgment sub-unit 152, configured to judge whether the area in which the location service terminal is located is a subscription area according to the received cell location information;

a third trigger sub-unit 180, configured to trigger the third judgment sub-unit 153 to judge whether the location information of the cell in which the location service terminal is located meets the target-area-triggered report rule, after the second judgment sub-unit 152 judges that the cell in which the location service terminal is located is a subscription area;

a third judgment sub-unit 153, configured to judge whether the location information of the cell in which the location service terminal is located meets the target-area-triggered report rule according to the received cell location information; and

a second sending sub-unit 132, configured to send the area-triggered notification information of the location service terminal, after the third judgment sub-unit 153 judges that the location information of the cell in which the location service terminal is located meets the target-area-triggered report rule.

In the embodiment of the location service server of the present invention, after the first judgment sub-unit 151 judges that the location service terminal undergoes area handover, the second judgment sub-unit 152 judges whether the area in which the location service terminal is located is a subscription area, the third judgment sub-unit 153 judges whether the location information of the cell in which the location service terminal is located meets the target-area-triggered report rule after the second judgment sub-unit 152 judges that the area in which the location service terminal is located is a subscription area, and the second sending sub-unit 132 sends outward the area-triggered notification information of the location service terminal after the third judgment sub-unit 153 judges that the current cell location information of the location service terminal meets the target-area-triggered report rule. Likewise, the location service terminal does not need to process the target-area-triggered report rule, which lowers the production cost of the location service terminal. In addition, when the target-area-triggered report rule is adjusted, the target-area-triggered report rule is directly adjusted at the location service server end, without the need of software upgrade of the location service terminal, which lowers the operation difficulty.

Referring to FIG. 7, FIG. 7 is a schematic diagram of a third trigger sub-unit in the location service server according to an embodiment of the present invention.

The third trigger sub-unit 180 includes:

a first trigger module 181, configured to trigger the subscription status judgment module 182 to judge the current subscription status of the location service terminal, after the second judgment sub-unit 152 judges that the area in which the location service terminal is located is a subscription area;

a subscription status judgment module 182, configured to judge the current subscription status of the location service terminal;

a second trigger module 183, configured to trigger the first sending unit 131 to send a cell handover subscription instruction to the location service terminal after the subscription status judgment module 182 judges that the current subscription status of the location service terminal is an area handover subscription status, and the location service terminal is in a cell handover subscription status after receiving the cell handover subscription instruction;

a third trigger module 184, configured to trigger the third judgment sub-unit 153 to judge whether the location information of the cell in which the location service terminal is located meets the target-area-triggered report rule, after the first sending unit 131 sends the cell handover subscription instruction to the location service terminal; and

a fourth trigger module 185, configured to trigger the third judgment sub-unit 153 to judge whether the location information of the cell in which the location service terminal is located meets the target-area-triggered report rule, after the subscription status judgment module 182 judges that the current subscription status of the location service terminal is a cell handover subscription status.

If the subscription instruction received by the location service terminal for the first time is an area handover subscription instruction, and then the location service terminal moves to a subscription area including a target area, the location service terminal needs to report its cell location information after cell handover, that is, the location service terminal is in a cell handover subscription status. In the device embodiment of the present invention, after the second judgment sub-unit 152 judges that the area in which the location service terminal is located is a subscription area, and the subscription status judgment module 182 judges that the current subscription status of the location service terminal is an area handover subscription status, the first sending unit 131 sends a cell handover subscription instruction to the location service terminal, and the location service terminal is in a cell handover subscription status, so that the location service terminal reports its cell location information after cell handover, and the location service server judges whether the location information of the cell in which the location service terminal is located meets the target-area-triggered report rule.

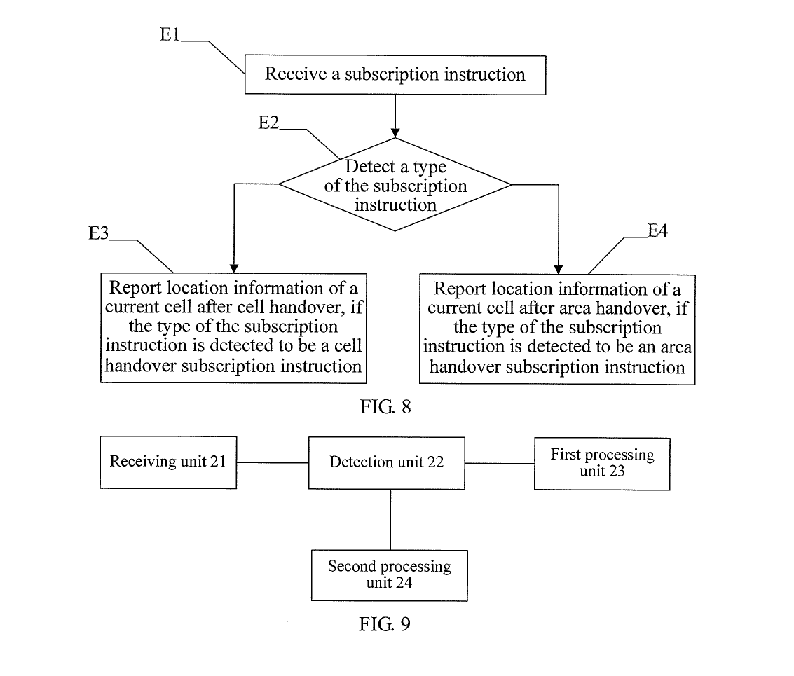

The following describes a process for implementing the subscription instruction from the location service terminal side. FIG. 8 is a flow chart of a method for processing a subscription instruction according to an embodiment of the present invention.

Step E1: Receive a subscription instruction.

The location service terminal receives the subscription instruction, where the subscription instruction may be delivered by the location service server, or forwarded by an intermediate device, such as an MSC.

Step E2: Detect the type of the subscription instruction.

The location service terminal detects the type of the subscription instruction according to the received subscription instruction, where the types of the subscription instruction include a cell handover subscription instruction and an area handover subscription instruction.

Step E3: Report location information of a current cell after cell handover, if the type of the subscription instruction is detected to be a cell handover subscription instruction.

If the subscription instruction is detected to be a cell handover subscription instruction, the location service terminal reports location information of a cell in which the location service terminal is currently located after detecting the occurrence of cell handover, that is, detecting the change of a Cellid.

Step E4: Report location information of a current cell after area handover, if the type of the subscription instruction is detected to be an area handover subscription instruction.

If the subscription instruction is detected to be an area handover subscription instruction, the location service terminal reports location information of a cell in which the location service terminal is currently located after detecting the occurrence of area handover, that is, detecting the change of an area identification.

When the location service terminal is in a target area, that is, the location service terminal is in a subscription area, the location service server sends a cell handover subscription instruction to the location service terminal, and the location service terminal is in a cell handover subscription status.

In the prior art, if the location service client requires the location service terminal to periodically report its cell location information, the location service terminal may continuously report its location information at a certain time interval when the location of the location service terminal is not changed, causing a waste of network resources. In the method embodiment of the present invention, the location service terminal reports the cell location information only after cell handover, so as to effectively avoid the unnecessary location report information of the location service terminal, and save the network resources.

Referring to FIG. 9, FIG. 9 is a schematic diagram of a location service terminal for processing a subscription instruction according to an embodiment of the present invention.

A receiving unit 21 is configured to receive a subscription instruction.

A detection unit 22 is configured to detect the type of the subscription instruction, where the types of the subscription instruction include a cell handover subscription instruction and an area handover subscription instruction.

A first processing unit 23 is configured to report location information of a cell in which the location service terminal is currently located, after the detection unit 22 detects that the subscription instruction is the cell handover subscription instruction, and the location service terminal undergoes cell handover.

A second processing unit 24 is configured to report location information of a cell in which the location service terminal is currently located, after the detection unit 22 detects that the subscription instruction is the area handover subscription instruction, and the location service terminal undergoes area handover.

Compared with the location service terminal in the prior art, in the embodiment of the location service terminal of the present invention, the location service terminal reports its cell location information only after area handover or cell handover, and does not need to process an area-triggered report rule, and the task of processing the area-triggered report rule is completed by the location service server, so that the production cost of the location service terminal is lowered, and the unnecessary location report information of the location service terminal can be effectively avoided, which saves the network resources.

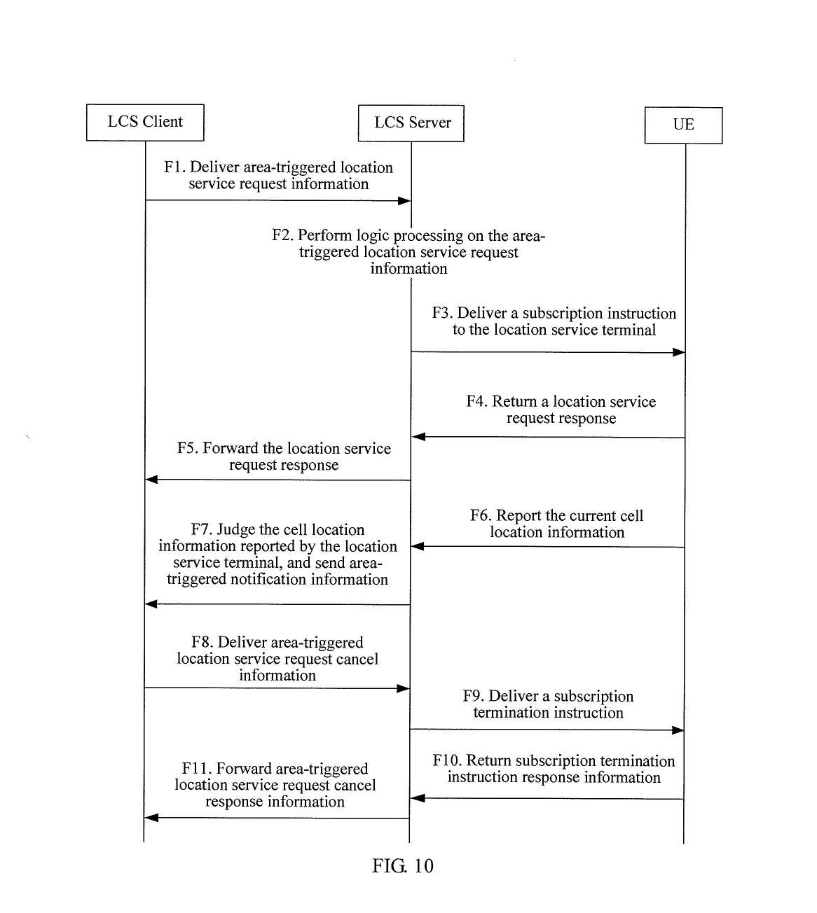

Referring to FIG. 10, FIG. 10 is a schematic diagram of a service process of an area-triggered location service system according to an embodiment of the present invention.

Step F1: Deliver area-triggered location service request information. The area-triggered location service request information delivered by a location service client to a location service server includes:

1) identification information of a location service terminal, where the identification information of the location service terminal is used to indicate the identity of a target user, and the location service client may have multiple user identifications carried in the area-triggered location service request information, to request location service report of multiple target users;

2) a target area, where the target area is generally a geographical area, and may be a geographical location name in an electronic map, for example, xx street and xx hotel, or an area identification of a mobile network, for example, an MCC, an MNC, or an LAI;

3) a trigger event type, for example, reporting in the case of entering, exiting, or being located in the target area;

4) a valid report time period carried in the request, for example, a start and an end report time; and

5) a target-area-triggered report rule, which is provided by the location service server. For example, location information is reported only once after the location service terminal undergoes area handover and the report of the location information is triggered, or for several times in the target area. A report policy may be divided into multiple types: for example, reporting after one time of cell handover, reporting several times at a time interval, or reporting following different rules in multiple time periods. If the area-triggered request requires reporting once only, the area-triggered location service request information is terminated when the location service terminal reports an area change notification once.

The location service server includes a triggered location service apparatus provided by the present invention, and the area-triggered report rule of the location service terminal can be flexibly set as follows:

1) Area-triggered information is reported only once to the location service client. After the area-triggered information notification is reported once, the location service server delivers a location service termination request to the location service terminal, and terminates the area-triggered subscription task of the location service client.

2) The area-triggered notification request is reported to the location service client only when the location service terminal enters or exits the target area.

3) The area-triggered notification information is reported to the location service client for several times, when the location service terminal is located in the area, For example, in the location area, the location service terminal reports the notification information after each time of cell handover. Alternatively, the area-change-triggered information is periodically reported to the location service client at a time interval. The manner of periodic report at a time interval does not require the location service terminal to report its location information, and the reported information is processed by the location service server.

4) The area-change-triggered report rule is set according to a time period. For example, from 10:00 am to 11:00 am, the location service terminal reports the area-change-triggered notification to the location service client after each time of cell handover in the target area, and from 3:00 pm to 5:00 pm, if the location service terminal is located in the target area, the location service terminal needs to periodically report the area-triggered notification to the location service client.

Step F2: Perform logic processing on the area-triggered location service request information. The location service server mainly performs the following logic processing:

1) saving the area-triggered subscription task delivered by the location service client;

2) searching an electronic map database through an electronic map conversion engine of the location service server, and converting the target area into a Cellid list including information such as an LAC identification, an MNC, and an MCC corresponding to the Cellid;

3) generating a unique req_id identifier for the request of the location service client, where the req_id identifier is corresponding to the request; therefore, parameters of the information exchanged between the location service server and the location service terminal, for example, delivered subscription instruction and location-triggered notification information reported by the location service terminal, and parameters of the information exchanged between the location service server and the location service client all carry req_id; and

4) judging, according to a black/white list set by the location service terminal, whether the location service terminal is permitted to be subscribed for its area-change-triggered information, and if the authorization fails, returning, by the location service server, subscription failure response information to the location service client.

Step F3: Deliver a subscription instruction to the location service terminal, also known as location service user equipment, UE.

The subscription instruction sent by the location service server may adopt SMS, USSD, or TCP/IP information.

The subscription instruction sent by the location service server to the location service terminal for the first time is not limited to a cell handover subscription instruction, and an area handover subscription instruction may also be used.

Three types of instructions are delivered from the location service server to the location service terminal:

1) Cell handover subscription instruction: The location service terminal reports its cell location information when undergoing Cellid cell handover;

2) Area handover subscription instruction: The location service terminal reports its cell location information when undergoing area handover; and

3) Termination subscription instruction: The location service terminal terminates the reporting of its location information.

Parameters of the instruction information delivered by the location service server to the location service terminal carry the req_id identifier.

Step F4: Return a location service request response. The location service terminal returns a location service request response to the location service server, where the returned response information carries the req_id identifier.

If the location service terminal does not support location subscription, the request information of the location service server is not responded. The location service server sends the subscription instruction to the location service terminal for several times, and if no response is made at any of the times, stops sending the subscription instruction to the location service terminal and meanwhile returns area-triggered location service failure response information to the location service client.

Step F5: The location service server forwards the location service request response to the location service client.

Step F6: The location service terminal receives the subscription instruction, and reports the location information of the cell in which the location service terminal is currently located.

Step F7: Judge the cell location information reported by the location service terminal, and send area-triggered notification information.

The location service server judges the cell location information reported by the location service terminal, and sends area-triggered notification information of the location service terminal to the location service client after judging that the cell location information of the location service terminal meets a triggered report condition, where a specific processing process of the location service server has been described in the method embodiment of the present invention, and will not be described in detail herein again.

Step F8: The location service client delivers area-triggered location service request cancel information to the location service server.

Step F9: The location service server delivers a subscription termination instruction.

The delivering, by the location service server, the subscription termination instruction to the location service terminal, is not limited to the delivery of the cancellation of the area-triggered subscription to the location service client, and when all target tasks related to the location service terminal are terminated, the location service server actively delivers the subscription termination instruction to the location service terminal.

Step F10: The location service terminal returns subscription termination instruction response information.

Step F11: The location service server forwards area-triggered location service request cancel response information to the location service client, to terminate the area-triggered location service request information, thereby terminating the area-triggered subscription process.

Specific application scenarios of the area-triggered location service method and apparatus, and the method and apparatus for processing the subscription instruction of the present invention are provided as follows.

1. A location service terminal user logs in to an advertisement subscription page provided by a location service client, selects advertisements that some areas would like to receive on this page, for example, film advertisements, catering advertisements, and commercial discounting advertisements in a busy civic center, and selects a time period and frequency that the area would like to receive the advertisements during the subscription.

2. The location service client initiates area-triggered location service request information of the location service terminal to the location service server. The request information carries parameter information such as identification information of the location service terminal, target area such as civic center, subscription start and termination time, and subscription frequency in the target area.

3. After receiving the location service request, the location service server convents geographical locations of the civic center into a specific Cellid list, and LAI, MNC, and MCC information through an electronic map conversion engine, and initiates a subscription instruction to the location service terminal.

4. When the location service terminal user enters, exits, or is located in the civic center, the location service terminal reports the Cellid cell information to the location service server, and the location service server detects the location change situation of the location service terminal user according to the Cellid cell information reported by the location service terminal. Then, according to the policy rule for the location service terminal to report its location information in the subscription task, for example, reporting by using multiple policies according to the time period when the location service terminal is located in the civic center, for instance, during 10:00 to 11:00, the location information is reported only in the case that the location service terminal enters or exits the civic center, and during 11:00 to 12:00, the location information is periodically reported at a time interval, the location service server reports area-triggered notification information of the location service terminal to the location service client, and the location service client transfers advertisements preferred by the location service terminal user by using a short message or a multimedia message according to the subscribed advertisement type after receiving the information.

The area-triggered location service method and the location service server and the location service terminal for implementing the method according to the present invention are described in detail above. Persons of ordinary skill in the art may make variations and modifications to the present invention in terms of the specific implementations and application scopes according to the ideas of the present invention. Therefore, the specification shall not be construed as a limit to the present invention.

What is claimed is:

1. An area-triggered location service method, comprising:
receiving, by a location service server, area-triggered location service request information;
saving, by the location service server, identification information of a location service terminal and a triggered report condition carried in the area-triggered location service request information;
sending, by the location service server, a subscription instruction to the location service terminal according to the identification information of the location service terminal, so that the location service terminal reports its location information after receiving the subscription instruction;
receiving, by the location service server, the location information reported by the location service terminal; and
judging, by the location service server, whether the location information meets the triggered report condition, and sending area-triggered notification information of the location service terminal if the location information meets the triggered report condition.

2. The area-triggered location service method according to claim 1, wherein the location service terminal reports its location information after receiving the subscription instruction comprises:
the location service terminal reports location information of a cell in which the location service terminal is located after cell handover or area handover after receiving the subscription instruction;
and the method further comprises:
receiving, by the location service server, the cell location information reported by the location service terminal; and
judging, by the location service server, whether the cell location information meets the triggered report condition, and sending area-triggered notification information of the location service terminal if the location information meets the triggered report condition.

3. The area-triggered location service method according to claim 2, wherein the judging whether the location information of the cell in which the location service terminal is located meets the triggered report condition specifically comprises:
judging, according to the received cell location information, whether the location service terminal undergoes area handover;
further judging whether the cell location information meets a target-area-triggered report rule, if it is judged that the location service terminal does not undergo area handover; and
judging that the cell location information meets the triggered report condition, if it is judged that the cell location information meets the target-area-triggered report rule.

4. The area-triggered location service method according to claim 2, wherein the judging whether the location information of the cell in which the location service terminal is located meets the triggered report condition specifically comprises:
judging whether the location service terminal undergoes area handover according to the received cell location information;
further judging whether an area in which the location service terminal is currently located is a subscription area, if it is judged that the location service terminal undergoes area handover;
further judging whether the cell location information meets a target-area-triggered report rule, after the area is judged to be a subscription area; and
judging that the cell location information meets the triggered report condition, if it is judged that the cell location information meets the target-area-triggered report rule.

5. The area-triggered location service method according to claim 4, further comprising:
further judging a current subscription status of the location service terminal, if the area is judged to be a non-subscription area; and
sending an area handover subscription instruction to the location service terminal, after the current subscription status of the location service terminal is judged to be a cell handover subscription status, so that the location service terminal reports location information of a cell in which the location service terminal is currently located after area handover after receiving the area handover subscription instruction.

6. The area-triggered location service method according to claim 4, wherein the area-triggered location service information further comprises target area information, and the judging whether the area in which the location service terminal is currently located is a subscription area comprises specifically:
judging the area to be a subscription area, if the area in which the location service terminal is currently located comprises a target area corresponding to the target area information; and
judging the area to be a non-subscription area, if the area in which the location service terminal is currently located does not comprise a target area corresponding to the target area information.

7. The area-triggered location service method according to claim 4, wherein after the area is judged to be a subscription area, the judging whether the cell location information meets the target-area-triggered report rule further comprises:
further judging a current subscription status of the location service terminal, after the area is judged to be a subscription area;
sending a cell handover subscription instruction to the location service terminal, if the subscription status is an area handover subscription status, so that the location service terminal reports location information of a cell in which the location service terminal is currently located after cell handover after receiving the cell handover subscription instruction, and then further judging whether the cell location information meets the target-area-triggered report rule; and
further judging whether the cell location information meets the target-area-triggered report rule, if the subscription status is a cell handover subscription status.

8. The area-triggered location service method according to claim 7, wherein the judging, according to the received cell location information, whether the location service terminal undergoes area handover further comprises:
judging that the location service terminal undergoes area handover, if the cell location information is reported by the location service terminal for the first time;
judging whether an area identification in the cell location information is changed, if the cell location information is not reported by the location service terminal for the first time, and judging that the location service terminal undergoes area handover, if the area identification is judged to be changed; and
judging whether the area identification in the cell location information is changed, if the cell location information is not reported by the location service terminal for the first time, and judging that the location service terminal does not undergo area handover, if the area identification is judged to be not changed.

9. The area-triggered location service method according to claim 7, wherein
the subscription instruction is an area handover subscription instruction or a cell handover subscription instruction.

10. A location service server, comprising:
a first receiving unit, configured to receive area-triggered location service request information;
a first storage unit, configured to save identification information of a location service terminal and a triggered report condition carried in the area-triggered location service request information;
a first sending unit, configured to send a subscription instruction to the location service terminal according to the identification information of the location service terminal saved in the first storage unit, so that the location service terminal reports its location information after cell handover or area handover after receiving the subscription instruction;
a second receiving unit, configured to receive the location information reported by the location service terminal; and
a processing unit, configured to judge whether the location information meets the triggered report condition, and send area-triggered notification information of the location service terminal after judging that the location information meets the triggered report condition.

11. The location service server according to claim 10, wherein the first sending unit further configured to send a subscription instruction to the location service terminal according to the identification information of the location service terminal saved in the first storage unit, so that the location service terminal reports location information of a cell in which the location service terminal is located after cell handover or area handover after receiving the subscription instruction;
the second receiving unit, further configured to receive the cell location information reported by the location service terminal; and
the processing unit, further configured to judge whether the cell location information meets the triggered report condition, and send area-triggered notification information of the location service terminal after judging that the cell location information meets the triggered report condition.

12. The location service server according to claim 11, wherein the processing unit comprises:
a first judgment sub-unit, configured to judge whether the location service terminal undergoes area handover according to the received cell location information;
a first trigger sub-unit, configured to trigger a third judgment sub-unit to judge whether the location information of the cell in which the location service terminal is located meets a target-area-triggered report rule, after the first judgment sub-unit judges that the location service terminal does not undergo area handover;
the third judgment sub-unit, configured to judge, according to the received cell location information, whether the location information of the cell in which the location service terminal is located meets the target-area-triggered report rule; and
a second sending sub-unit, configured to send the area-triggered notification information of the location service terminal, after the third judgment sub-unit judges that the location information of the cell in which the location service terminal is located meets the target-area-triggered report rule.

13. The location service server according to claim 11, wherein the processing unit comprises:
a first judgment sub-unit, configured to judge, according to the received cell location information, whether the location service terminal undergoes area handover;
a second trigger sub-unit, configured to trigger a second judgment sub-unit to judge whether the area in which the location service terminal is located is a subscription area, after the first judgment sub-unit judges that the location service terminal undergoes area handover;
the second judgment sub-unit, configured to judge, according to the received cell location information, whether the area in which the location service terminal is located is a subscription area;
a third trigger sub-unit, configured to trigger a third judgment sub-unit to judge whether the location information of the cell in which the location service terminal is located meets the target-area-triggered report rule, after the second judgment sub-unit judges that the cell in which the location service terminal is located is a subscription area;
the third judgment sub-unit, configured to judge whether the location information of the cell in which the location service terminal is located meets the target-area-triggered report rule according to the received cell location information; and
a second sending sub-unit, configured to send the area-triggered notification information of the location service terminal, after the third judgment sub-unit judges that the location information of the cell in which the location service terminal is located meets the target-area-triggered report rule.

14. The location service server according to claim 13, wherein the third trigger sub-unit comprises:
a first trigger module, configured to trigger a subscription status judgment module to judge a current subscription status of the location service terminal, after the second judgment sub-unit judges that the area in which the location service terminal is located is a subscription area;
the subscription status judgment module, configured to judge the current subscription status of the location service terminal;
a second trigger module, configured to trigger the first sending unit to send a cell handover subscription instruction to the location service terminal, after the subscription status judgment module judges that the current subscription status of the location service terminal is an area handover subscription status;
a third trigger module, configured to trigger the third judgment sub-unit to judge whether the location information of the cell in which the location service terminal is located meets the target-area-triggered report rule, after the first sending unit sends the cell handover subscription instruction to the location service terminal; and
a fourth trigger module, configured to trigger the third judgment sub-unit to judge whether the location information of the cell in which the location service terminal is located meets the target-area-triggered report rule, after the subscription status judgment module judges that the current subscription status of the location service terminal is a cell handover subscription status.

15. A location service terminal, comprising:
a receiving unit, configured to receive a subscription instruction;
a detection unit, configured to detect the type of the subscription instruction;
a first processing unit, configured to report location information of a cell in which the location service terminal is currently located, after the detection unit detects that the type of the subscription instruction is a cell handover subscription instruction, and the location service terminal undergoes cell handover; and
a second processing unit, configured to report location information of a cell in which the location service terminal is currently located, after the detection unit detects that the type of the subscription instruction is an area handover subscription instruction, and the location service terminal undergoes area handover.
